(19) United States
(12) Patent Application Publication
(10) Pub. No.: US 2005/0033636 A1
(43) Pub. Date: Feb. 10, 2005

(54) Advertisement creation support system and advertisement creation support control method

(76) Inventors: Shuhei Miura, Chuo-ku (JP); Yasuyuki Tanaka, Chuo-ku (JP); Yuji Ono, Chuo-ku (JP)

Correspondence Address: JOHN S. PRATT, ESQ;KILPATRICK STOCKTON, LLP, 1100 PEACHTREE STREET, ATLANTA, GA, 30309, US

(21) Appl. No.: 10/495,051

(22) PCT Filed: Nov. 5, 2002
(86) PCT No.: PCT/JP02/11527

(30) Foreign Application Priority Data
Nov. 5, 2001 (JP) 2001-338805

(51) Int. Cl. G06F 17/60

(52) U.S. Cl. 705/14

(57) ABSTRACT

The present invention includes a production managing server and a plurality of staff terminals. The production managing server manages production information for each staff member engaged in production of an advertisement. Each of the plurality of staff terminals transmits a report indicating completion of work contents to the production managing server. When receiving the report from any one of the terminals, the production managing server notifies the other staff terminals of an instruction to advance a subsequent process.

The present invention relates to an advertisement production support system which manages production information including work content and progress in various processes until an advertisement is produced.

### BACKGROUND ART

Advertisement production is associated with so-called printed matters such as newspapers and magazines, broadcast media such as TV or radio commercials, and interactive media such as an Internet advertisement. The advertisement production involves a producer of an advertisement organizing an advertiser's demands into an advertising matter. The created advertisement, that the advertiser wants, is inserted (broadcasted) in advertising media and broadly published.

Until this advertising is carried out, first, a plurality of staff members for producing an advertisement participate and play respective roles. The respective production staff members perform planning, comprehensive production, designing, finishing, and correction to receive final confirmation from the advertiser. Thereafter, the completed advertisement is sent to companies which deal with newspapers, magazines, and the like. The companies which received the advertisement insert the advertisement into a particular paper and the like.

Specifically, first, a plurality of production staff members necessary for producing an advertisement are brought together. Project details of the advertisement are conveyed to the plurality of production staff members from an indicator. Each of the production staff members who received the project details performs his/her own distributed work. The advertisement production proceeds by this series of processes.

Such proceeding is made mainly by the indicator. Upon completion of work by a staff member, this indicator sequentially gives an instruction to a staff member assigned to a subsequent work (in baton relay style). As shown in FIG. 1, production staff members A to X participate in this system with the indicator as the leader. Each of these staff members A to X performs his/her own work according to an instruction from the indicator and reports the result thereof to the indicator. The indicator who received the result of the work instructs another member of the production staff members A to X to start the subsequent work.

In such a flow of processes, the indicator bears a great burden because of sequentially giving instructions. Moreover, the production staff members A to X engaged in the work are required to report modified information to the other production staff members A to X each time modifying changes are made by the indicator. Accordingly, each of the production staff members A to X also bears a great burden.

On the other hand, the indicator for advertisement production bears the burden of managing the production staff members, and moreover, the indicator must control various administrative affairs. Examples of the administrative affairs include scheduling between the production staff members, schedule management concerning advertisement production, cost management, quality management, updating of the latest information, and management of the progress of the respective production staff members.

In recent years, the emergence of the Internet has changed bands from narrow bands to broad bands. This has enabled the production staff members to send/receive advertisement data of a large amount to/from each other. Moreover, confirmation of the contents of the advertisement and the like which have been carried out through a meeting, a telephone, or a facsimile can now be carried out through a browser on the Internet. Accordingly, the production staff members can easily confirm each other's progress at any time.

As described above, while the social environment is changing, realization of a seamless digital workflow supporting a network is being desired in advertisement production. However, in a method of connecting the work units, each of which is digitalized, a production staff member hands over an advertisement manuscript to the indicator or the like, or a postal service delivers the advertisement manuscript with a motorcycle or the like. Accordingly, the flow of work remains unchanged from a conventional one. Therefore, though the work efficiency of each production staff member is increased, costs for producing an advertisement are increased in accordance with the cost invested in digital equipment in some cases since the entire flow of work remains unchanged from the conventional one.

Therefore, the present invention was made in light of the aforementioned problem, and an object thereof is to provide an advertisement production support system which can efficiently support work related to advertisement production via a network.

### DISCLOSURE OF THE INVENTION

In order to achieve the aforementioned objective, the present invention according to the application includes a production managing server and a plurality of terminals. In management of production information including work contents and progress in various processes until an advertisement is produced, the production managing server manages the production information for each staff member engaged in the production of the advertisement, and each of the terminals transmits a report indicating completion of the work contents to the production managing server. When receiving the report transmitted from any one of the terminals, the production managing server notifies another one of the terminals of an instruction to advance a subsequent process.

In the above present invention, preferably, the production managing server verifies a password transmitted from any one of the terminals and pieces of authentication information previously stored, and when able to retrieve one of the pieces of authentication information which matches the password, the production managing server displays the production information managed in the production managing server on a screen of the terminal of interest.

In the above present invention, preferably, the production information includes an image or text for use in production of the advertisement as production material, and the production managing server verifies the password transmitted from any one of the terminals and the pieces of authentication information previously stored, and when able to retrieve one of the pieces of the authentication information which matches the password, the production managing server transmits the production material managed in the production managing server to the terminal of interest.

In the above present invention, preferably, the plurality of terminals transmits the hours which have been required for completing the work contents, to the production managing server by input operations by the staff members, and the production managing server calculates costs, which have been required for producing the advertisement, according to the hours transmitted from the terminals. Moreover, the production managing server preferably calculates the costs, which have been required for producing the advertisement, according to the amount of data of the produced advertisement.

### BRIEF DESCRIPTION OF THE DRAWINGS

FIG. 1 is a view showing a conventional flow to produce an advertisement.

FIG.2 is a conceptual view showing an advertisement production support system of the present invention.

FIG. 3 is a block diagram showing an internal structure of a production managing server.

FIG. 4 is a view showing a display of an interface and various functions.

FIG. 5 is a flowchart showing a flow of a method of controlling advertisement production support of the present invention.

FIG. 6 is a view showing processing details performed in staff terminals.

FIG. 7 is a view showing the flow of data transmission/reception performed between an indicator terminal and a staff terminal.

FIGS. 8A to 8C are views showing a series of display contents displayed on screens of the staff terminals (No. 1).

FIGS. 9A to 9C are views showing a series of display contents displayed on the screens of the staff terminals (No. 2).

FIGS. 10A and 10B are views showing a flow until the indicator terminal notifies the staff terminals of the progress of works.

FIG. 11 is a view showing a flow in which each production staff member starts or completes his/her own work (No. 1).

FIG. 12 is a view showing a flow in which each production staff member starts or completes his/her own work (No. 2).

FIG. 13 is a conceptual view showing a total advertisement production support system of the present invention.

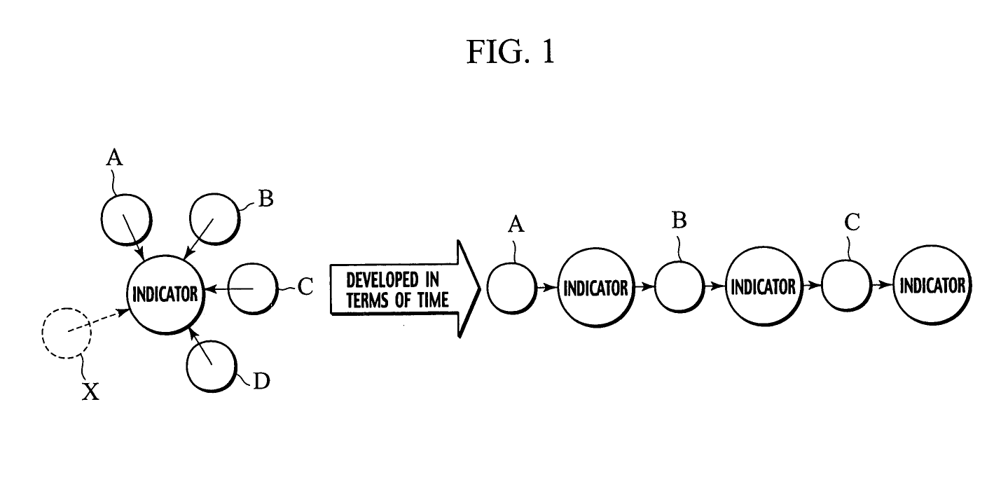

### BEST MODE FOR CARRYING OUT THE PRESENT INVENTION

A detailed description will be given below of an advertisement production support system and an advertisement production support control method according to the present invention with reference to the drawings showing embodiments thereof.

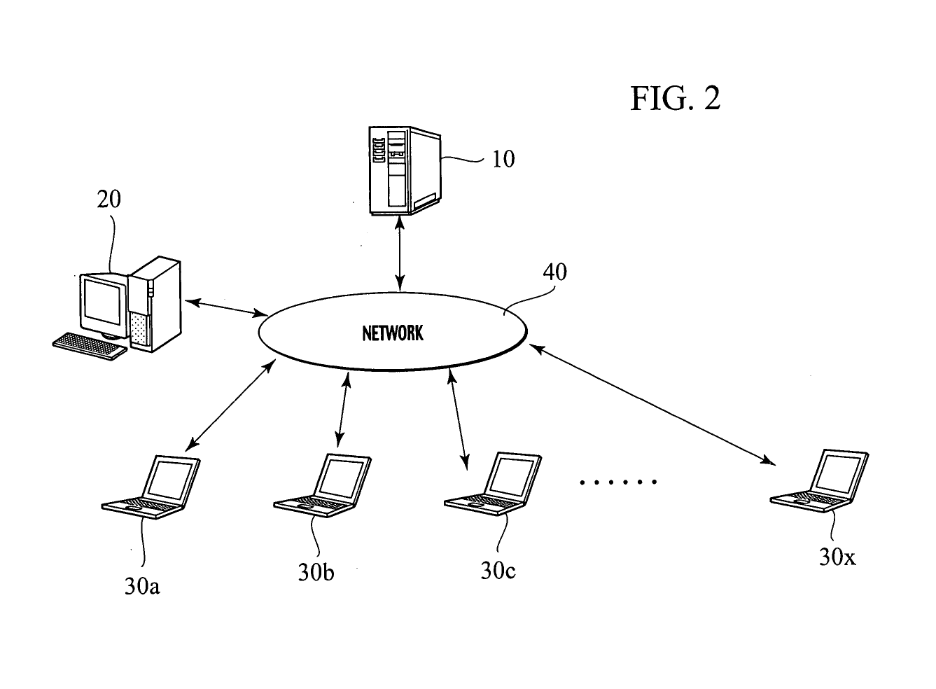

FIG. 2 is a view showing a schematic configuration of the advertisement production support system according to the embodiment. As shown in FIG. 2, the advertisement production support system manages production information including work contents and progress in various processes until an advertisement is produced.

This advertisement production support system includes a production managing server 10, an indicator terminal 20, and staff terminals 30a to 30x in this embodiment, which are connected to a network 40. Examples of the network 40 are the Internet, an intranet, a LAN, a private line, and the like.

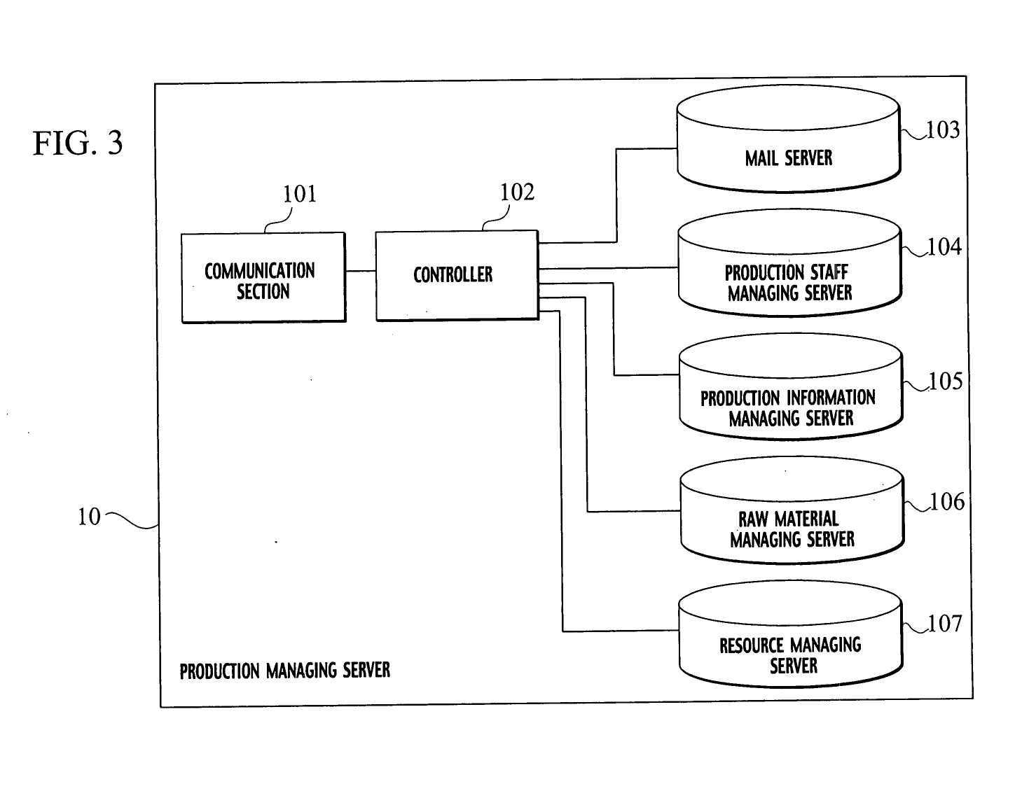

As shown in FIG. 3, the production managing server 10 includes a communication section 101, a controller 102, a mail server 103, a production staff managing server 104, a raw material managing server 106, and a resource managing server 107. The communication section 101 allows the indicator terminal 20 and the staff terminals 30a to 30x to transmit/receive data to/from each other via the network 40.

The controller 102 manages the entire production managing server 10. This controller 102 is, for example, a CPU, or the like. The mail server 103 stores addresses with which various types of information are transmitted to the indicator terminal 20 and the staff terminals 30a to 30x. The production staff managing server 104 stores names of a plurality of production staff members involved in the production of an advertisement or authentication information for authenticating the production staff members. The production information managing server 105 stores the various types of production information. The raw material managing server 106 stores advertisement raw material. The resource managing server 107 stores an advertisement resource.

Specifically, the production managing sever 10 manages the production information for each staff member engaged in the production of the advertisement. Moreover, when receiving a report indicating completion of work from any one of the staff terminals 30a to 30x, the production managing server 10 notifies the other staff terminals 30a to 30x of an instruction to advance the subsequent process step. The later described indicator terminal 20 and each of the staff terminals 30a to 30x can update information (production information) on advertisement production and the like.

In addition, the production managing server 10 verifies a password input by any one of the production staff members A to X and each piece of authentication information previously stored. When able to retrieve a piece of authentication information which matches the password, the production managing server 10 displays the production information managed by the production managing server 10 on an appropriate screen of the staff terminals 30a to 30x.

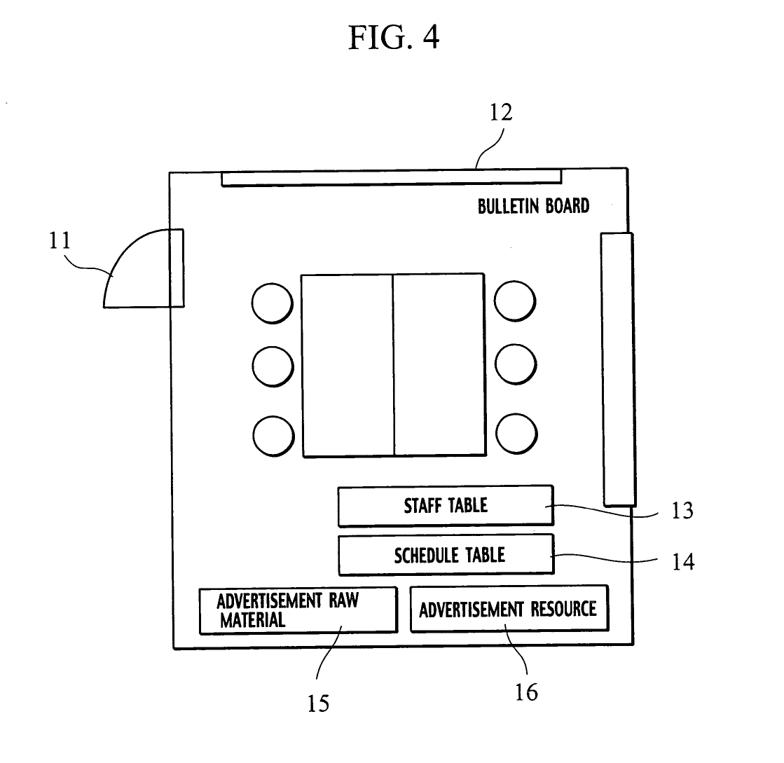

Herein, the production managing server 10 displays, for example, a project room in a virtual space on screens of the indicator terminal 20 and the staff terminals 30a to 30x as shown in FIG. 4. On each of the screens, a door 11 allowing the production staff members A to X to login is arranged. When each of the production staff members A to X clicks the door 11 with a mouse, a dedicated screen for login is displayed. Each of the production staff members A to X can login by inputting an identifier, in the dedicated screen, previously acquired from the work indicator.

In the project room in the virtual space, a bulletin board 12 for reporting work contents, a staff table 13 for displaying names of the production staff members engaged in the production, and a schedule table 14 showing time limits of works to which the respective staff members A to X are assigned are arranged.

In addition, an advertisement raw material 15 (production material) and an advertisement resource 16 (production material) are displayed in the project room. The advertisement raw material 15 indicates electronic data composed of predetermined patterns, texts, persons, logos, illustrations, photographs, images, and the like for use in production of an advertisement. The advertisement resource 16 indicates electronic data already completed such as newspaper or magazine advertisements already published. In this embodiment, this advertisement raw material 15 indicates electronic data of advertisements not yet published, and the advertisement resource 16 indicates electronic data of advertisements already published.

The production staff members A to X can freely download the advertisement raw material 15 and the advertisement resource 16. Specifically, the production managing server 10 verifies a password received from any one of the staff terminals 30a to 30x and pieces of authentication information previously stored, and retrieves one of the pieces of authentication information which matches the password. The production managing server 10 which has retrieved the authentication information transmits the advertisement raw material 15 or the advertisement resource 16, which is managed by the production managing server 10, to the appropriate staff terminals 30a to 30x according to an instruction by one of the production staff members.

Therefore, a system manager can keep the advertisement raw material 15 and the advertisement resource 16 and the like a secret since log management is carried out by the production managing server 10. Furthermore, since the log management is carried out by the production managing server 10, each of the production staff members A to X can communicate with the other production staff members A to X at any time through the production managing server 10.

Moreover, since the bulletin board 12, the staff table 13, and the schedule table 14 are arranged in the project room in the virtual space, each of the project staff members A to X can clearly have knowledge of the roles of the other production staff members A to X and their work portion thereof through the arranged bulletin board 12 and the like. Furthermore, work reports from the production staff members A to X who have finished his/her own work are incorporated in the schedule table 14, which allows the production staff members A to X to share his/her own data.

The indicator terminal 20 gives instructions concerning the advertisement production to the staff terminals 30a to 30x through the production managing server 10. Specifically, the indicator terminal 20 causes the production managing server 10 to store production information created by the indicator. This production information includes contents of work to be carried out by the respective production staff members A to X and the like. The staff terminals 30a to 30x display the production information stored by the production managing server 10 according to instructions from the respective production staff members A to X. The production staff members A to X see the production information displayed on the screens and perform his/her own work.

The staff terminals 30a to 30x transmit reports indicating completion of work to the production managing server 10. The staff terminals 30a to 30x cause the production managing server 10 to store data created by the production staff members A to X. Furthermore, the staff terminals 30a to 30x notify the production managing server 10 of progress (completion of work, sending of work to be completed, and the like) of work in which the respective production staff members A to X are engaged.

The staff terminals 30a to 30x transmit hours, which have been required for the respective work, to the production managing server 10 by input operations by the production staff members A to X. The production managing server 10 preferably calculates costs, which have been required for producing the advertisement, according to the sum of hours transmitted from the staff terminals 30a to 30x.

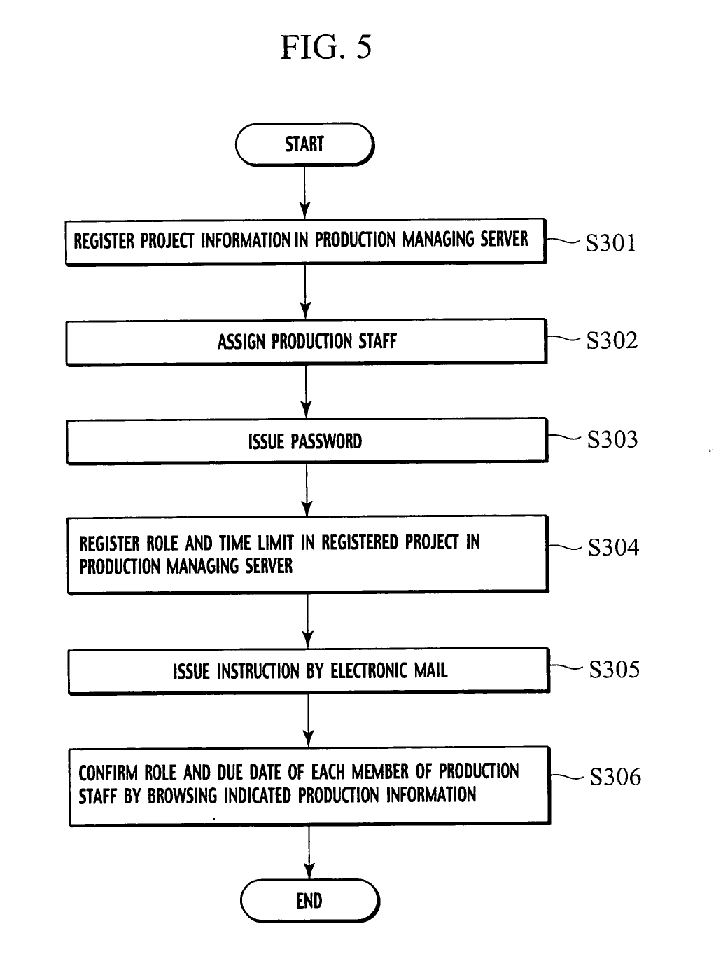

The advertisement production support control method according to the advertisement production support system having the aforementioned configuration can be implemented by the following procedure. FIG. 5 is a flowchart showing a procedure of the advertisement production support control method.

As shown in FIG. 5, first, the indicator causes the production information to be stored (registered) in the production managing server 10 by use of the indicator terminal 20 (S301). Herein, a piece of production information is composed of, for example, the work name, the work category, work contents, and a time limit for the work to be completed and the like. This piece of production information is created for each production staff member whom the indicator is to assign.

Subsequently, the indicator inputs names of the production staff members A to X, with which the production staff members A to X participate in the advertisement production support system, by use of the indicator terminal 20 (S302). Specifically, the indicator terminal 20 registers the names of the production staff members A to X in the production managing server 10.

The production managing server 10 then issues passwords for the inputted names of the individual production staff members A to X (S303). The passwords are ones issued in subscription or the like. Subsequently, the production managing server 10 associates the inputted names of the production staff members A to X with the pieces of production information corresponding to the respective production staff members A to X (S304).

Subsequently, the production managing server 10 notifies the staff terminals 30a to 30x used by the staff members A to X of the pieces of production information associated with the respective production staff members A to X (S305). The production staff members A to X browse the notified pieces of production information through the respective staff terminals 30a to 30x and confirm his/her own work and time limits thereof (S306).

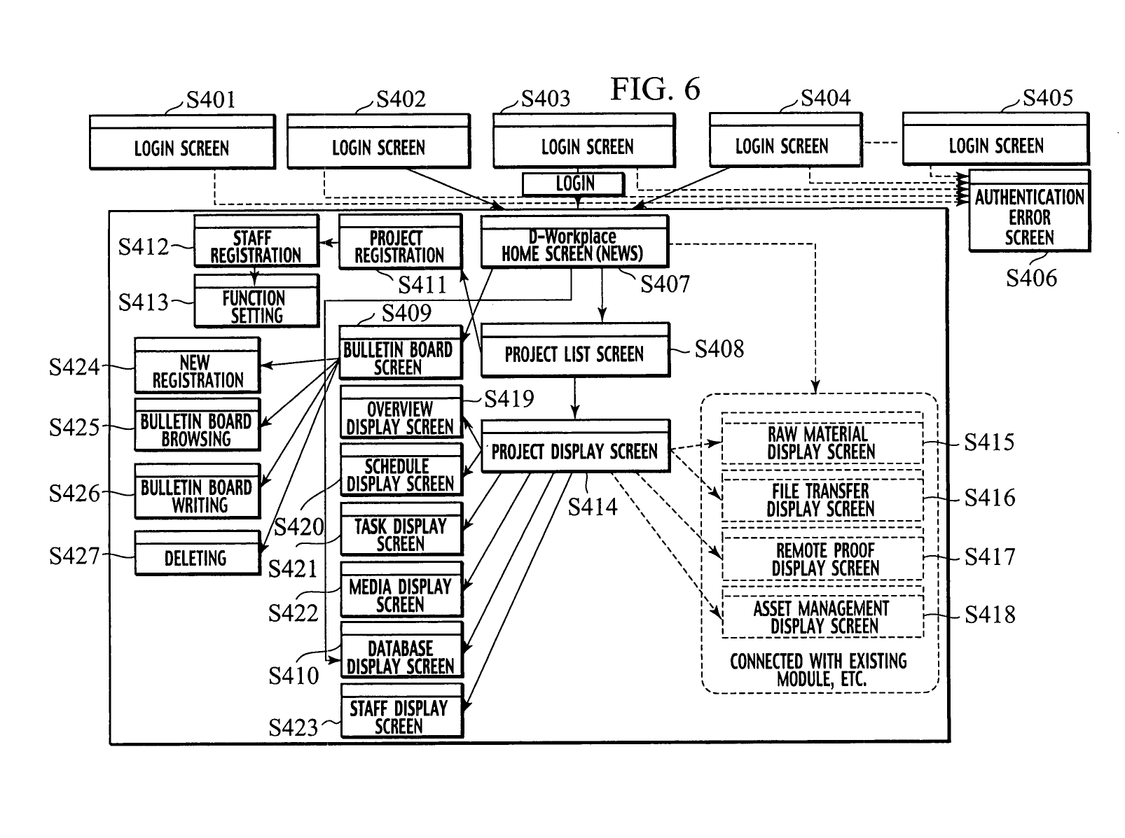

Specifically, the production staff members A to X acquire the respective passwords through issuing by the production managing server 10. The production staff members A to X who have acquired the respective passwords input the acquired passwords into the staff terminals 30a to 30x for logon. As shown in FIG. 6, when logging on, the production staff members A to X are allowed to browse various types of information through the staff terminals 30a to 30x (S401 to S405). Note that the indicator can browse the above various types of information through the indicator terminal 20.

Specifically, upon receiving the password from the production staff members A to X, each of the staff terminals 30a to 30x verifies the password and the pieces of authentication information previously registered. When a piece of authentication information which matches the inputted password can be retrieved, the staff terminals 30a to 30x which have performed the verification allow logon. On the contrary, when the piece of authentication information which matches the inputted password cannot be retrieved, each of the staff terminals 30a to 30x displays an error screen (S406).

When the logon succeeds, each of the staff terminals 3Oa to 3Ox displays a home screen (S407). In this home screen, items for selecting the next screen and the like are displayed. Each of the production staff members A to X can proceed to a project list screen (S408) for displaying a list of the production information or to a bulletin board screen (S409) for showing progress and the like.

Furthermore, each of the production staff members A to X can also proceed to a database display screen (S410) for displaying various types of data stored in a production management database, a row material display screen (S415) for displaying the advertisement raw material 15 and the like, a file transfer display screen (S416) for transferring formats of various types of files into different formats, a remote proof display screen (S417), and an asset management display screen (S418).

From the project list screen (S408), each of the production staff members A to X can proceed to a project registration screen (S411) allowing the indicator to register the production information and a staff registration screen (S412) allowing the indicator to enter the names of the production staff members A to X. Furthermore, from the project list screen (S408), each of the production staff members A to X can proceed to a project display screen (S414) for displaying the individual pieces of production information.

From this project display screen, the production staff members A to X can proceed to the aforementioned screens (S415 to S418). Moreover, from the project display screen, the production staff members A to X can proceed to an overview display screen (S419) for displaying a list of information related to the production information, a schedule display screen (S420) for displaying time limits of work of the respective production staff members A to X, a task display screen (S421), a media display screen (S422), the database display screen (S410), and a staff display screen (S423) for displaying a list of production staff members A to X who are participating in the system.

From the bulletin board screen (S409), the production staff members A to X can proceed to a new registration screen (S424) for registering a new person who is allowed to write in the bulletin board, a bulletin board browsing screen (S425) for browsing details of information written in the bulletin board, a bulletin board write screen (S426) for writing information in the bulletin board, and a screen (S427) for deleting information written in the bulletin board.

Herein, the various types of information managed by the production managing server 10 can be accessed by the indicator and all of the production staff members A to X through the indicator terminal 20 and the staff terminals 30a to 30x. The production staff members A to X engaged in work can know the latest information concerning production of the advertisement by accessing the production managing server 10 through the staff terminals 30a to 30x.

Examples of information which the indicator and the production staff members A to X are able to know are the work contents, the categories, and the time limits of work, the working hours (hours which have been required for work), the numbers of steps of the work, the work information reports including deliverables, and the work reports indicating the completion of the work by the respective production staff members A to X. Particularly, the working hours and the number of steps of the work are the most important items in budgeted management.

The production managing server 10 which has received the work report from any one of the staff terminals 30a to 30x notifies the other staff terminals 30a to 30x of the work report or an instruction to advance the subsequent process. This notification can be performed through electronic mails. The production managing server 10 which has received the working hours from the staff terminals 30a to 30x calculates costs, which have been required for producing the advertisement, according to the received working hours.

Therefore, the production managing server 10 can instantaneously calculate production costs arising from the production staff members A to X performing the works since the production managing server 10 can manage these pieces of information. Moreover, the indicator and the like can know easily at which stage the costs are higher since the indicator and the like can refer to the production costs according to the working hours of the production staff members.

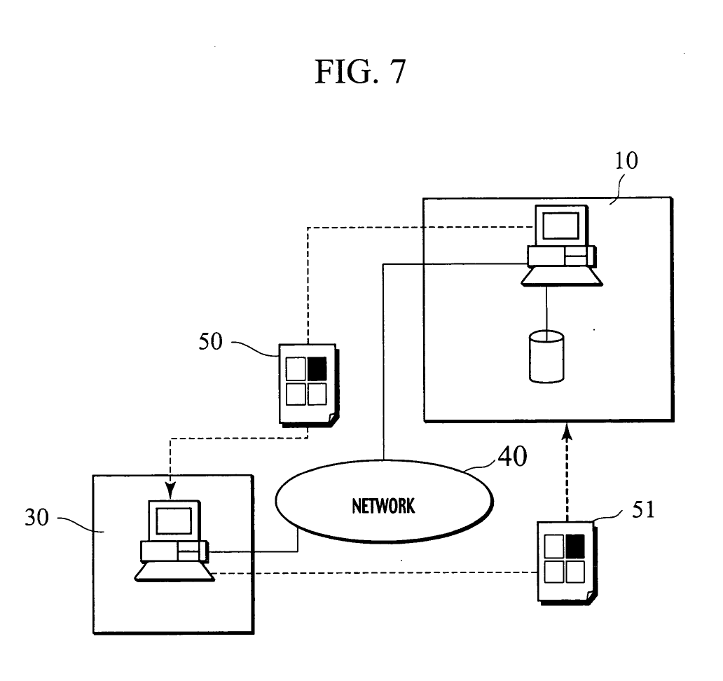

As shown in FIG. 7, for example, when the production staff members A to X produce an advertisement, each of the production staff members A to X acquires advertisement production information 50 including the work contents, the time limit, the entire work schedule, the advertisement raw material, and the advertisement resource from the production managing server 10 by use of a staff terminal 30.

Each of the production staff members A to X who have acquired the advertisement production information 50 produces deliverables for his/her own work based on the acquired advertisement production information. The staff terminals 30a to 30x store the produced deliverables in the production managing server 10 as the advertisement completion information 51. This allows all of the production staff members A to X and the indicator to share the information such as the work reports.

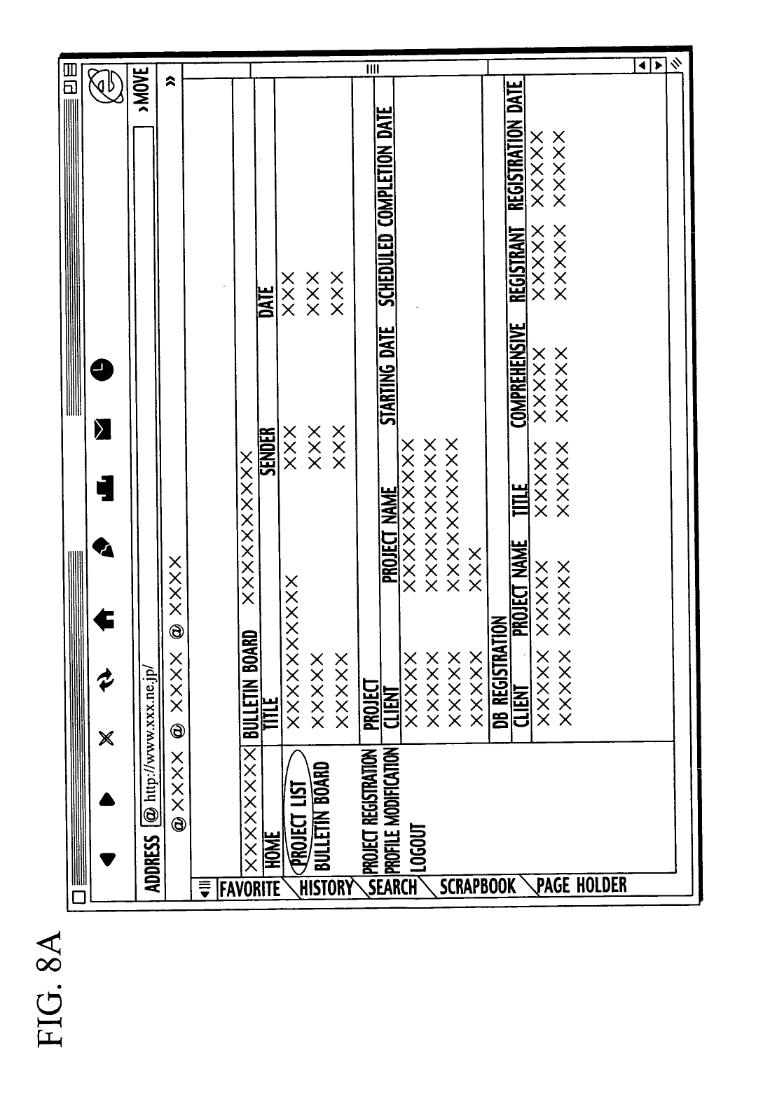

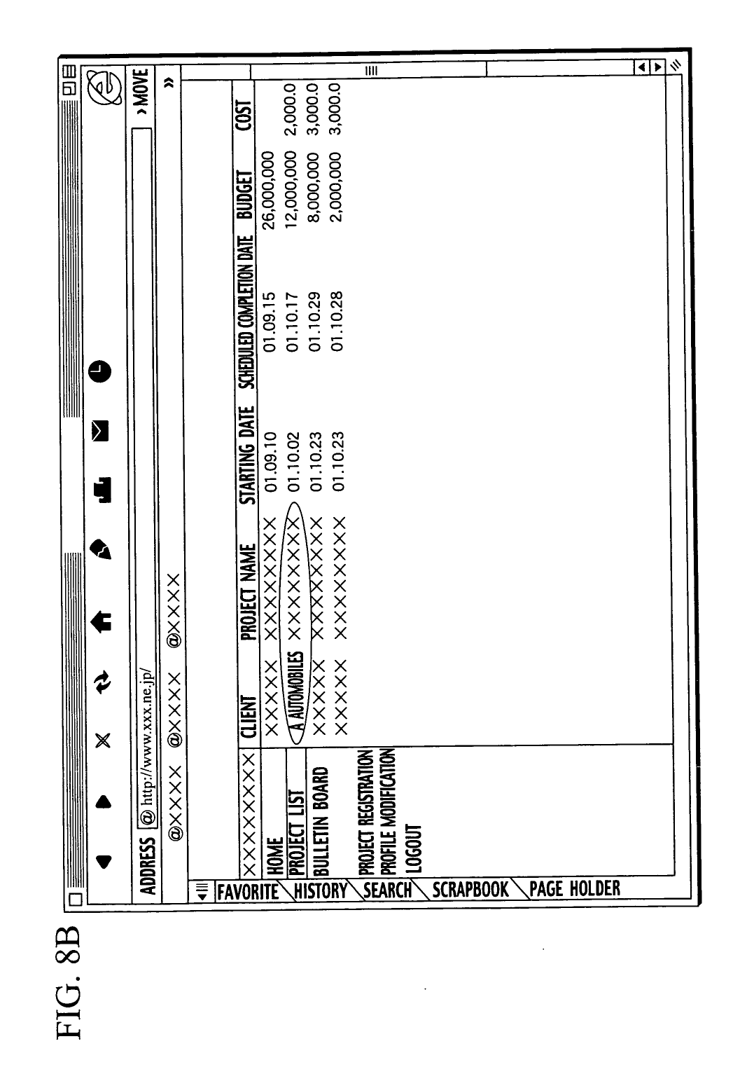

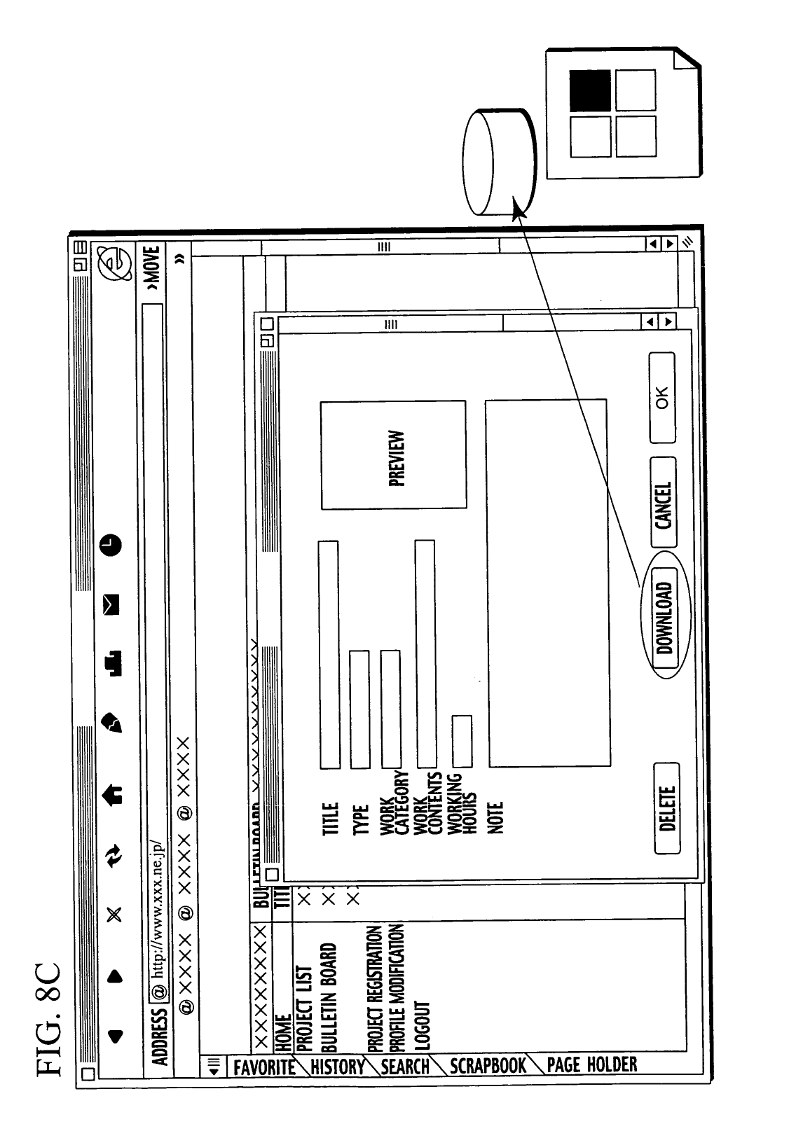

At the start of producing an advertisement, each of the production staff members A to X confirms his/her own production information (title only) on a screen as shown in FIG. 8A. Each of the production staff members A to X can perform the confirmation by clicking an encircled place shown in FIG. 8A with a mouse.

Each of the production staff members A to X who have performed the confirmation selects given production information (encircled place) as shown in FIG. 8B. Each of the production staff members A to X who have performed the selection confirms the details (title, work category, etc.) of the production information as shown in FIG. 8C. The staff terminals 30a to 30x download data files concerning the production information, based on instructions from the production staff members A to X.

Each of the staff terminals 30a to 30x which have finished downloading reports the starting of work to the production managing server 10. The production managing server 10 which has received the report notifies the other staff terminals 30a to 30x of the production staff members A to X of the starting of work.

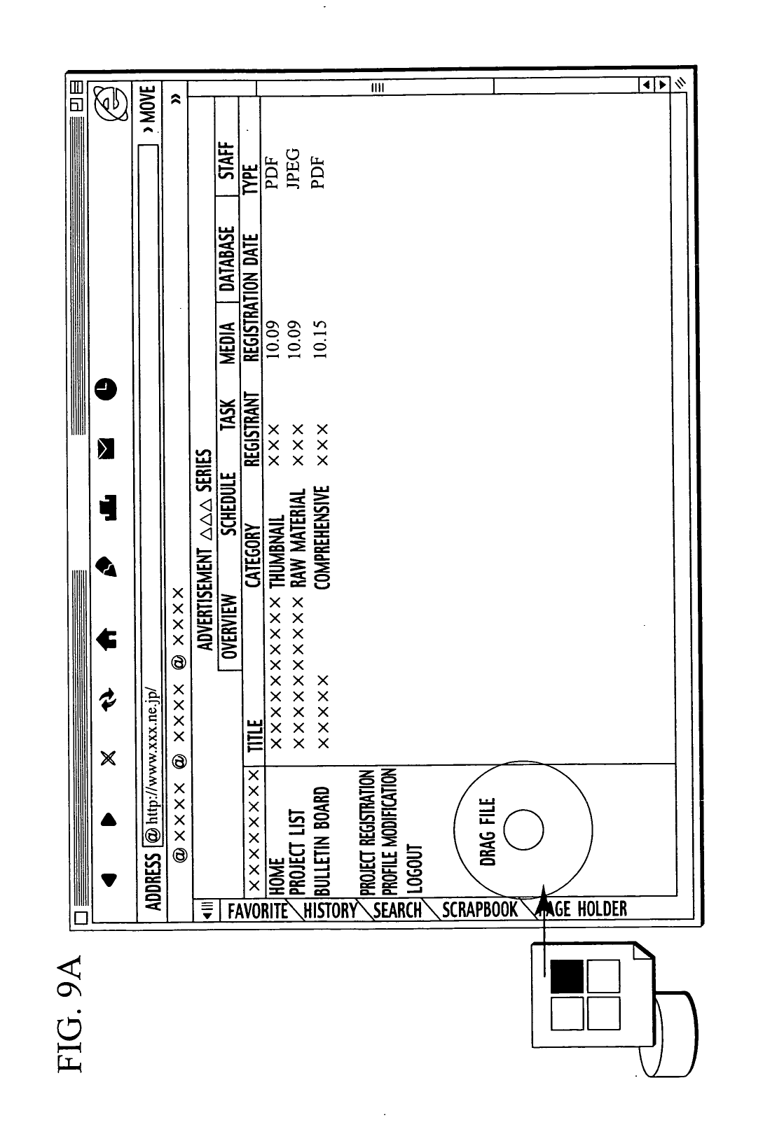

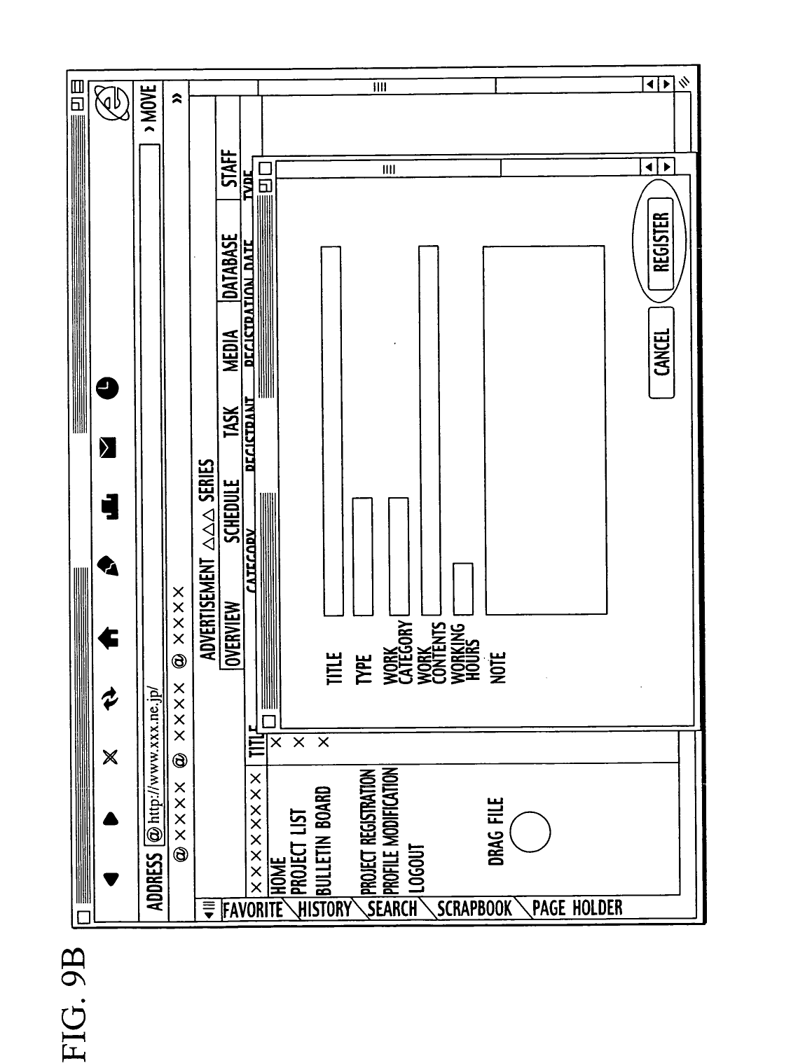

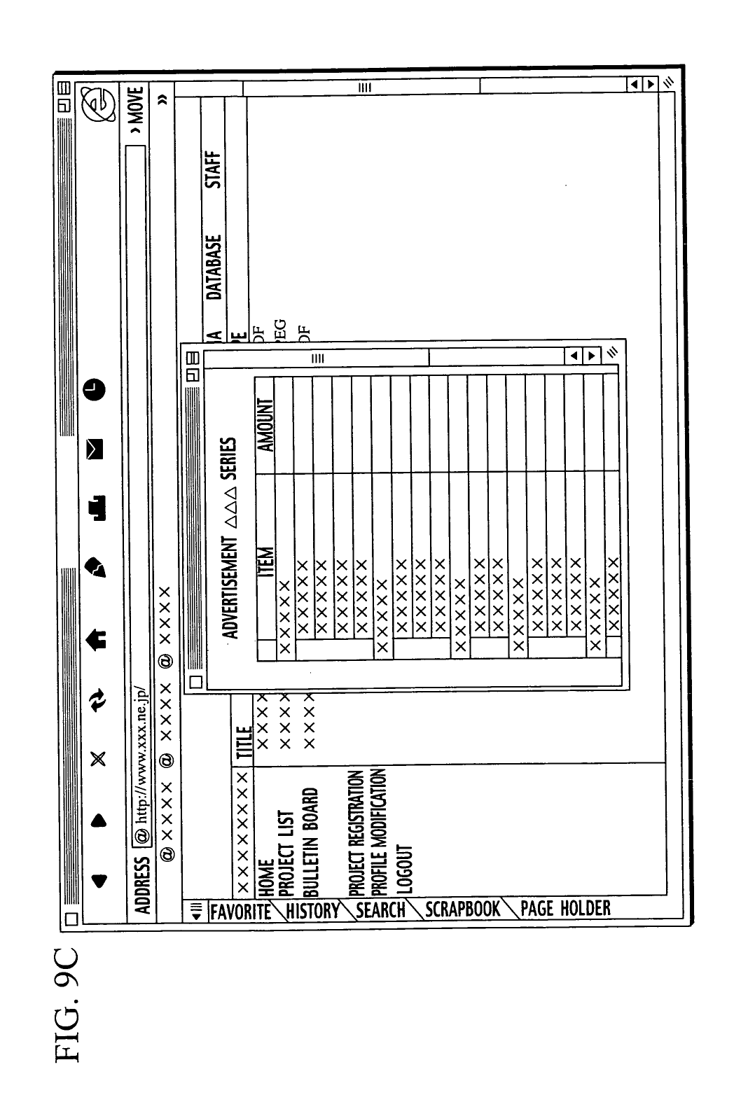

As shown in FIG. 9A, for reporting the completion of work to the production managing server 10, the production staff members A to X select a piece of the production information corresponding to the completed work and drags and drops a data file as deliverables to a place indicated by the production managing server 10.

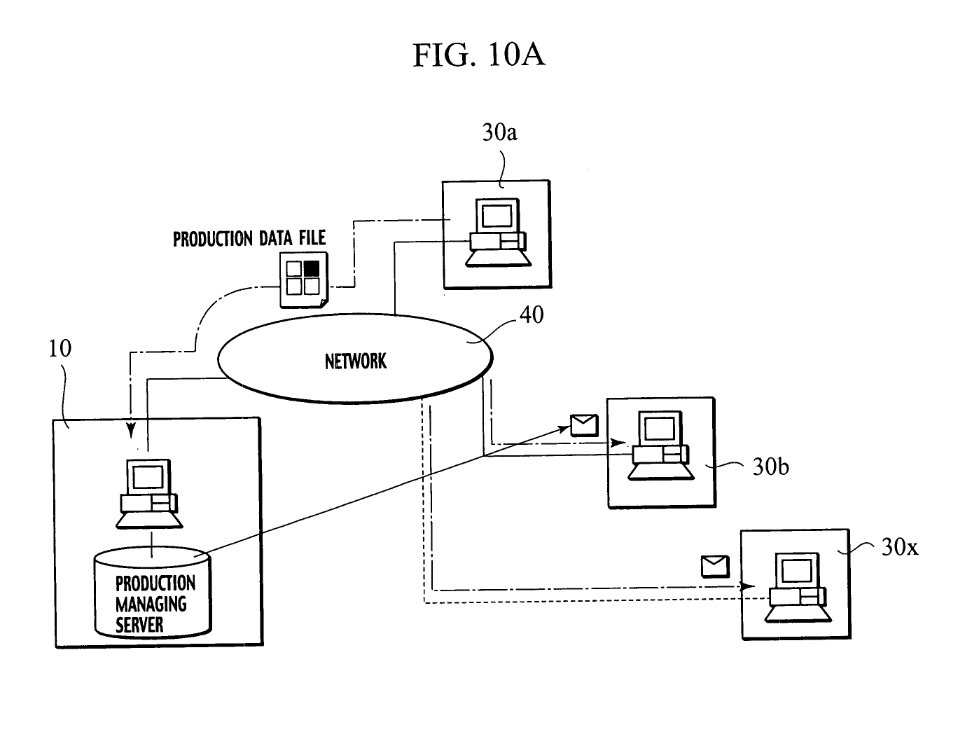

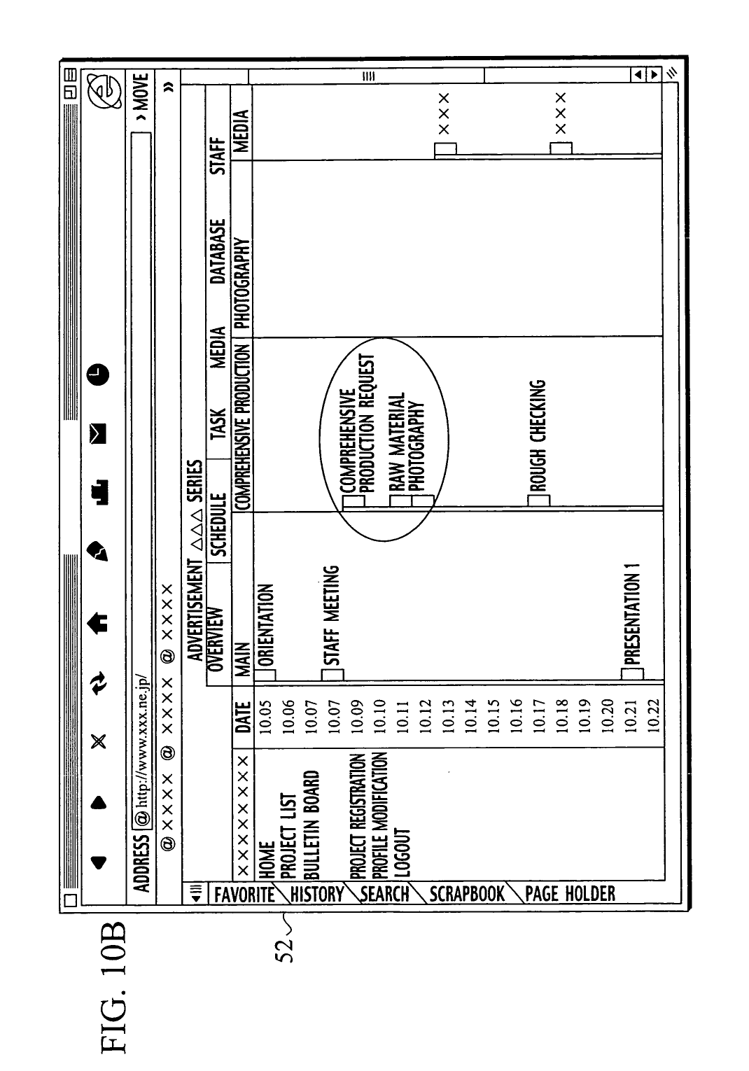

Subsequently, as shown in FIG. 9B, a dialog in which the work contents and the like are entered is displayed on the screen. The production staff members A to X enter information in predetermined fields. When the entry is completed and the production staff members A to X click “registration”, a dialog in which work breakdown is entered is displayed on the screen as shown in FIG. 9C. The production staff members A to X enter predetermined information in specific places of the dialog. As shown in FIG. 10A, the entered information (production data file) is stored in the production managing server 10.

As shown in FIG. 10B, the production managing server 10 storing the information updates the completed part in the schedule table 52. Moreover, the production managing server 10 which has received the work report from any one of the staff terminals 30a to 30x notifies the contents of the report to the other staff terminals 30a to 30x.

In this embodiment, as described above, all the information on the advertisement production is managed by the production managing server 10. Accordingly, the indicator and each of the production staff members A to X can easily have knowledge on the progress of work of other production staff members A to X through the network 40. Moreover, the production staff members A to X can efficiently perform work concerning the advertisement production since the production staff members A to X can easily have knowledge on the progress of work of the other production staff members A to X.

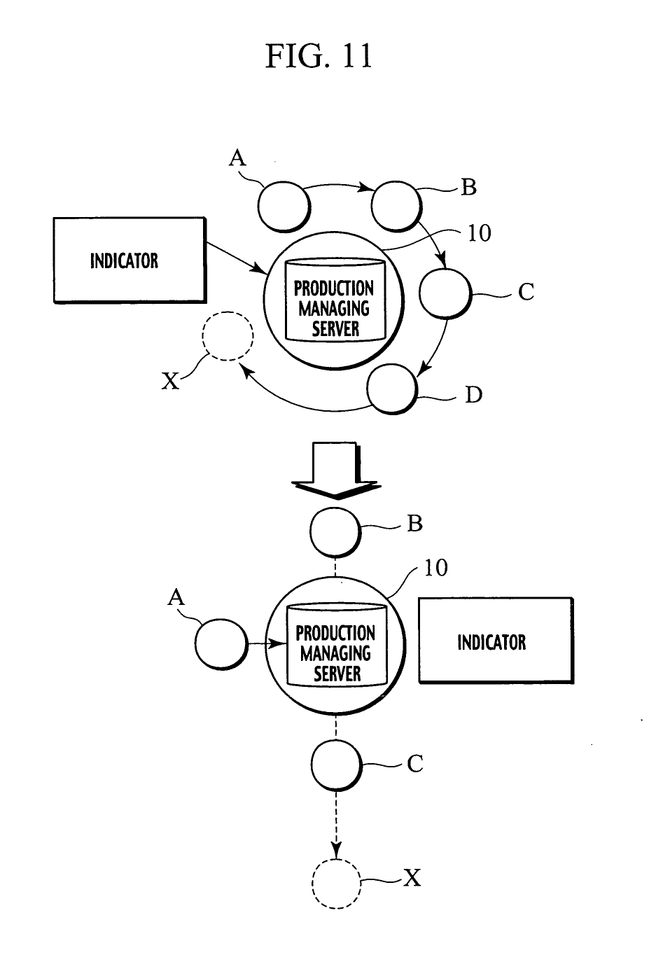

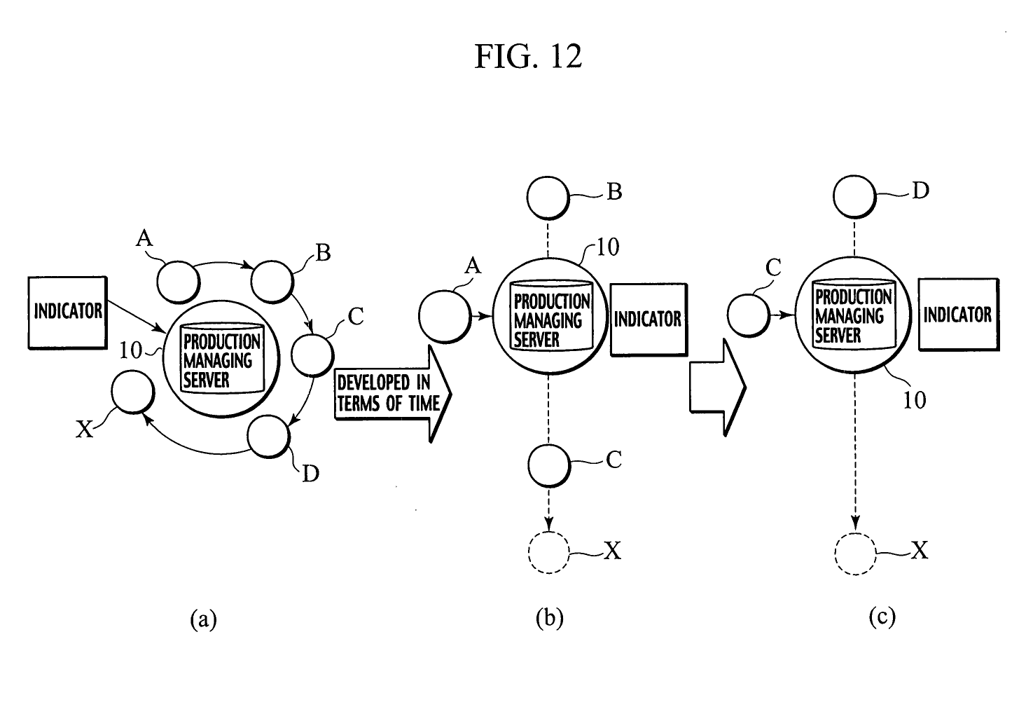

Specifically, as shown in FIG. 11 and FIGS. 12A to 12C, the production staff members A to X send data as deliverables to the production managing server 10 through the staff terminals 30a to 30x after the indicator registers the pieces of production information in the production managing server 10 for the respective production staff members A to X through the indicator terminal 20. The production managing server 10 which has received the data notifies the indicator terminal 20 and the other production staff members A to X of the reception of the data.

Therefore, the production staff members A to X can easily know the latest information on progress. Moreover, each of the production staff members A to X are spared the effort of asking other production staff members A to X to confirm the present progress. Furthermore, a manager of the production managing server 10 can save time on delivering various types of advertisement manuscripts (deliverables) by post to the other production staff members A to X since the production managing server 10 sends the deliverables of each of the production staff members A to X through electronic mails and the like. Accordingly, the manager can reduce costs generated in distributing the advertisement manuscripts and the like.

As shown in FIG. 12A, based on the work report from each of the production staff members A to X, the production managing server 10 instantaneously notifies the production staff members A to X associated with the subsequent work of that work report. Accordingly, each of the production staff members A to X can easily know the progress of the other production staff members A to X, thus reducing the time for waiting for a connection from the other production staff members A to X.

As shown in FIG. 12B, when a work of the production staff member A is completed, the deliverables from the work are uploaded to the production managing server 10. This enables the production staff member B to easily understand that the baton can be passed to his/her own work. Simultaneously, the production staff member C can prepare for starting his/her own work.

As shown in FIG. 12C, in the case where the production staff member C reports his/her own work report to the production managing server 10, the production managing server 10 notifies the production staff members D and X, and the like of that report. Accordingly, the production staff member C eliminates the need to report the completion of his/her own work to the production staff members A and B who were involved in the previous work and can be instantaneously engaged in another task.

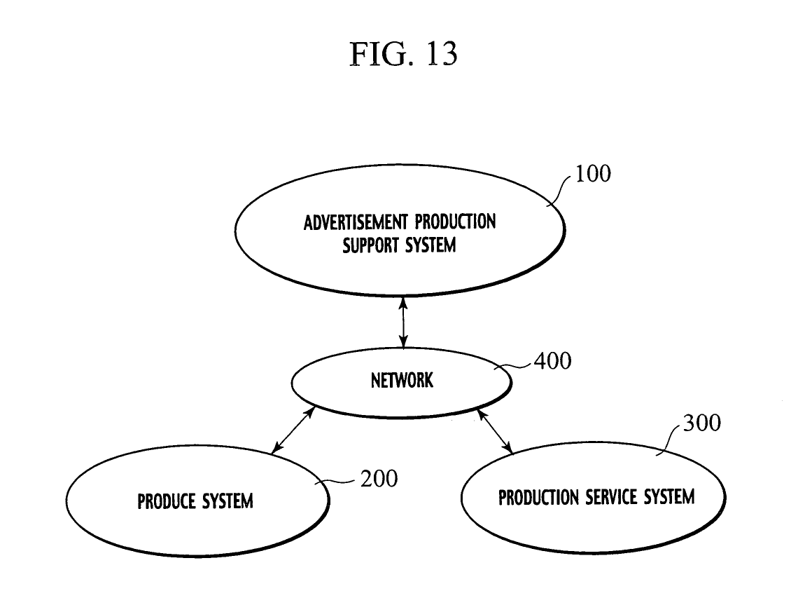

As shown in FIG. 13, an advertisement production support system 100 can be combined with, for example, a produce system 200 and a production service system 300 to make a total advertisement production support system. This total advertisement production support system seamlessly performs all processes including production, manuscript transfer, and distribution of advertisements. In addition, the total advertisement production support system can provide a total solution service of advertisement production by a single manager. This produce system 200 and the production service system 300 are connected to the advertisement production support system 100 through a network 400.

The advertisement production support system 100 performs the same processing as described above. Specifically, this advertisement production support system 100 can perform processing mainly in support or management of advertisement production. This advertisement production support system 100 can carry out various types of functions by activating an “AD manager” (generic term) as a tool supporting advertisement production and managing processes thereof.

Accordingly, each of the production staff members can perform workflow management such as confirmation of progress of the other production staff members and his/her own report by using an activated browser. Moreover, the management of information on production schedule, production costs, production staff, correction, and quality can be unified by the advertisement production support system 100.

The advertisement production support system 100 can carry out a function to manage the advertisement raw material 15 or the advertisement resource 16 with information added thereto, such as copyright, right of portrait, expiration date, and restrictions by activating “digital assets management (DAM)” (generic term).

The produce system 200 performs entire production affairs such as production management and operation. Moreover, the produce system 200 updates information managed by the advertisement production support system 100 and changes the flow of production works according to instructions by a producer of digital advertisement production.

This advertisement production support system 100 corresponds to the indicator terminal 20. Therefore, the produce system 200 can manage the entire production works including progress thereof which is managed by the advertisement production support system 100.

The production service system 300 performs all the affairs concerning creation and correction of advertisements and the like. Specifically, the production service system 300 performs general production operations such as scanning of image raw materials, retouching, creation and correction of digital data to be transferred, various outputs of DDCP, and checking of final data. This production service system 300 corresponds to the staff terminals 30a to 30x . A printing section (prepress and printing) performs the central part in the production operations for printing work (printing media).

Persons performing the production operations can provide consulting on printing for advertisement production companies and collaborative companies through the production service system 300. Data treated in the production service system 300 can be stored in the aforementioned production managing server 10 through the “AD manager”.

This embodiment can be applied not only to the field of advertisement but also to a creative field, a field requiring collaboration, and the like.

Industrial Applicability

As described above, according to the present invention, a production staff member can easily have knowledge on the progress of other production staff members through a network. Accordingly, an indicator leading advertisement production and each production staff member can efficiently perform works assigned thereto.

1. An advertisement production support system which manages production information including work contents and progress in various processes until an advertisement is produced, the system comprising:
a production managing server managing the production information for each staff member engaged in production of the advertisement; and
a plurality of terminals each of which transmits a report indicating completion of the work contents to the production managing server; wherein
when receiving the report transmitted from any one of the plurality of terminals, the production managing server notifies another one of the terminals of an instruction to advance to a subsequent process.

2. The advertisement production support system according to claim 1, wherein the production managing server verifies a password transmitted from any one of the terminals and pieces of authentication information previously stored, and when able to retrieve one of the pieces of authentication information which matches the password, the production managing server transmits the production information managed in the production managing server to the terminal [symbol] managing server notifies another one of the terminals of an instruction to advance a subsequent process.

4. The advertisement production support system according to claim 3, wherein
the plurality of terminals transmit hours, which have been required for completion of the work contents, by input operations from the staff members to the production managing server, and
the production managing server calculates costs, which have been required for producing the advertisement, according to hours transmitted from the terminals.

5. (Deleted)

6. (Deleted)

7. A method of controlling advertisement production support, where a production managing server managing various types of information manages production information by instructions from terminals, the production information includes work contents and progress in various processes until an advertisement is produced, the method comprising:
a first step of verifying, by the production managing server with input operation by each staff member engaged in production of the advertisement, a password transmitted from any one of the terminals and pieces of authentication information previously stored, and when one of the pieces of authentication information which matches the password is retrieved, transmitting by the production managing server the production information including advertisement data not yet published to the terminal of interest; and
a second step , where the production managing server receives a report which indicates that the work contents are completed based on the production information received by the terminal of interest, and notifying by the production managing server to another one of the terminals of an instruction to advance a subsequent process.

8. The method of controlling advertisement production support according to claim 7, further comprising:
a third step of transmitting hours, which have been required for completion of the work contents, to the production managing server by the terminals in response to input operations by staff members; and
a fourth step of calculating by the production managing server cost, which have been required for production of the advertisement, according to the hours transmitted from the terminals.
